(19) United States
(12) Patent Application Publication
(10) Pub. No.: US 2026/0343217 A1
(43) Pub. Date: Oct. 29, 2026

(54) Method,Programs, Datasets, computer-readable Data Carrier, Secure Element, User Device and Server Device for Configuring dynamic Data Subsets based on Connection Capabilities

(71) Applicant: Giesecke+Devrient Mobile Security Germany GmbH, Munich (DE)

(72) Inventor: Jordi Monter Prat, Dulles, VA (US)

(73) Assignee: Giesecke+Devrient Mobile Security Germany GmbH, Munich (DE)

(21) Appl. No.: 19/554,684

(22) Filed: Mar. 3, 2026

Related U.S. Application Data
(60) Provisional application No. 63/766,138, filed on Mar. 3, 2025.

(51) Int. Cl. H04W 12/033; H04W 12/08

(52) U.S. Cl. CPC H04W 12/033; H04W 12/08

(57) ABSTRACT

A method, as well as a corresponding configuration program, a application program dataset, a user profile dataset, a computer-readable data carrier, a secure element, a user device, and a server device are provided, for configuring the user device, in particular for communication via mobile telecommunication networks, the method comprises the steps of preparing a user profile dataset for a user to operate a secure element, such as an eUICC, of the user device, based on diversified data for personalizing the se-cure element, providing the user profile dataset to the secure element selecting at least a part of a dynamic data subset of the user profile dataset based on a connection capability of the user device.

### CROSS REFERENCE TO RELATED APPLICATIONS

This application claims the benefit of U.S. provisional application No. 63/776,138 filed Mar. 3, 2025, which is hereby incorporated in its entirety by reference.

### TECHNICAL FIELD

The present disclosure relates to the field of configuring user devices, for example, mobile devices or Internet-of-Things (IoT) devices, for participating in communication networks. In particular, the present disclosure relates to a method of configuring a secure element for a user device, in particular for communication via mobile telecommunication networks, a configuration program for configuring a secure element for a user device, an application program dataset for operating a secure element of a user device, in particular for communication via mobile telecommunication networks, an application program dataset for operating a secure element, such as an eUICC, of a user device, in particular for communication via mobile telecommunication networks a user profile dataset for a secure element, such as an eUICC, of a user device, in particular for communication via mobile telecommunication networks, a computer-readable data carrier, a secure element for a user device, in particular for communication via mobile telecommunication networks, a user device, in particular a mobile device or an IoT device to be configured for communication via mobile telecommunication networks by a user, and a server device, in particular a security server providing a secure location for handling user profiles for enabling access to mobile telecommunication networks.

### BACKGROUND

User devices, such as personal mobile devices or IoT-devices, configured to employ electronic user and/or subscriber profiles for communicating on mobile networks, are known from the prior art. Such user devices are typically equipped with an electronic/embedded secure element (SE, eSE), also known as tamper resistant element (TRE), which may take the form of an UICC, eUICC, iUICC, SIM, eSIM, iSIM, or alike, configured to store one or more electronic user or subscriber profiles that may allow the user devices to connect to one or more mobile networks. A subscriber profile (e.g., a SIM profile, an eSIM profile, etc.) may be generated by a mobile network operator (MNO) and may be stored, e.g., downloaded to a mobile user device. Alternatively, or additionally, the subscriber profiles or user profiles may be stored on pluggable SIMs which can then be inserted into the user device.

The secure elements are run by operation systems (OS) containing software and/or firmware for operating the secure elements. Those OS need to be up to date in order to provide full and reliable functionality of the secure elements. An OS Update is especially relevant with the deployment of embedded Secure Elements (eSE) in the form of eUICC or alike. As opposite of traditional pluggable SIMs that can be inserted and removed, eSEs are soldered into user devices, making it very difficult (or costly) to replace them during the life cycle of the user devices.

The user and/or subscriber profile is commonly based on so-called diversified data relating to an intended user and installed on a secure element of the user device to be used for communication over a corresponding mobile network by the user device. A respective user or subscriber can then activate the profile by means of respective security credentials, such as profile identifiers, authentication certificates and/or security keys which can be stored on the secure element along with the OS. This commonly requires a so-called trusted party or entity that can be provided on SE/TREs and/or servers, such as eSIM download servers, from which respective SE/TRE data records can be obtained or managed, such as Subscription Manager Data Preparation platforms (SM-DP+) while fulfilling respective security requirements.

Hence, the subscriber profile, i.e. a structure and format thereof, as well as the respective diversified data, including security credentials, etc., should be adapted to the respective OS. According to the prior art, there are a number of ways of installing the subscriber profile on a SE/TRE, which may include providing the diversified and/or personalized data to the SE/TRE. In general, this can be done either via normal commands communicating with the OS or in other ways during production in factory, for example, by a so-called “Diversified Data Injection” referring to a deployment of different data for each SE/TRE in factory before issuance of the SE/TRE to a customer. For example, respective data can be provided “Over-the-air” (OTA) in that a production facility for secure elements and/or a manufacturing facility for user devices downloads the data over a network “OTA” for installation.

WO 2023/274583 A1, for example, relates to a method, on a data generation server, for preparing generating a profile image for download from a profile server to an eUlCC hosted in a device, for the purpose of installing a profile corresponding to the profile image in the eUlCC, the method comprising the steps: a) at a data generation server, generate, for multiple devices, multiple non-personalized profile images, each non-personalized profile image comprising at least one functionality identifier specific for the respective device, and each non-personalized profile image not comprising any individual global identifier specific of an individual eUlCC, and store the generated multiple non-personalized profile images for providing to the profile server; b) at the data generation server, generate at least one profile-data image, said profile-data image comprising at least one individual global identifier of an individual eUlCC, and store the generated at least one profile-data image (RD) for providing (GD) to the profile server.

WO 2023/016669 A1 relates to a method in a secure element (SE), including the following method steps: obtaining, in the SE, an identity query, in particular a GET IDENTITY command, sent by a network; encrypting, by means of the SE, identity data stored on the SE, in order to generate encrypted identity data using a symmetrical key generated in the SE before the obtaining step; applying, by means of the SE, a message authentication code (MAC) algorithm to the generated encrypted identity data in order to obtain a MAC; and creating and sending a response to the identity query from the SE to the network, wherein the message contains the encrypted identity data and the MAC. An SE is provided for a computer program product, and a system comprising a SE and a network.

WO 2022/159355 A1 refers to an eSIM software for creating eSIMs running within a trusted, secure private network of a wireless communication services provider (“WSP”), receiving information entered by a user via a user interface to create or modify eSIM profile templates. Real-time alerts may notify that user-entered mismatched data precludes generation of eSIMs that will function in authenticating to the network. eSIMs created within the WSP secure private network may be shared outside of the secure private network using information entered via a Partner user interface accessed using credentials that grant limited access to modify an eSIM profile template. An eSIM profile may be generated and stored on a case-by-case basis instead of generating all of a large quantity, or batch, and then storing all of the batch. Transport of highly guarded security information, like master keys, outside of the secure private network does not occur.

WO 2019/120609 A1 describes a method of adaptive generation of a profile package, said profile package being constructed to, when being downloaded to an eUICC and installed in the eUICC, install a profile in the eUICC. Further described is a method of adaptive generation of a code package, said code package being constructed to, when being downloaded to a device and installed in the device, install an executable code in the device. The executable code can be an operating system. Accordingly, a batch of multiple profile (or code) descriptions is provided, instead of providing a batch of ready-made profile (or code) packages. When a target eUICC/ target device requests to the transfer server download of a profile (code) package, the target eUICC/target device or some other competent instance provides the transfer server with configuration information of the target eUICC/target device. The transfer server retrieves, instead of a ready-made profile (code) package (eSIM), only a profile (code) description and profile (code) data. The transfer server then, via execution of the profile description together with the profile data, generates the profile package adaptively, therein flexibly considering the configuration information on the target eUICC/target device. By this adaptive way of profile generation, profile packages matching with the real target eUICC/target device are generated. Such a matching profile package can be successfully installed in the eUICC.

US 2014/128050 A1 proposes a method of provisioning connectivity service data for a device when the device attaches to a telecommunications network. The connectivity service data comprises information required to enable connectivity between the device and at least one further device of the network. Dynamic data relating to the device is obtained as part of one of the devices attaching to the telecommunications network and a previous attachment of the device to the network. The dynamic data is of a type that may change from one such attachment to another such attachment of the same device. The connectivity service data is then selected based on the obtained dynamic data. It is then arranged for the selected connectivity service data to be provisioned to the device.

Furthermore, it has to be considered that different user devices support different technical features, functionalities and have respective capabilities, such as supporting a certain communication standard. For example, some devices support 5G networks, while others only offer 4G capabilities. In combination with eSIM technology, thereby situations are created that can lead into incompatibilities between devices and eSIMs if they are not aligned in the technology supported or the version of the standards supported by each component.

For example, eSIM explicit support for 5G was introduced in Trusted Connectivity

Alliance (TCA) Profile Package Interoperability Technical Specification Format version 2.3.1 (also called SIMAlliance Interoperability Profile). Several versions of the Profile Package Interoperable Technical Specification have been released. Therefore, the support of 5G and/or backward compatibility cannot be guaranteed anymore.

Specifically, TCA SAIP V2.3.1 (Annex F) provides a description and recommendation in regards of incompatibilities among versions (including 5G related topics). For 5G, the following statement is made in regards of profiles supporting 5G: “The installation of a V2.3 or higher profile requesting SUCI calculation (i.e. PE SAIP and/or PE 5GS included and service n°124 and/or service n°125 available in the EF_UST) on an eUICC that supports a version of this specification lower than V2.3 will be aborted according to the mandated rules in this version of the specification. NOTE: In case a V2.3 profile requesting SUCI calculation (i.e. DF 5GS and/or DF SAIP and service n°124 and/or service n°125 are available in the EF_UST) would be downloaded on an eUICC that does not support SUCI calculation and this eUICC is soldered or inserted in a 5G ME, the service indicators related to SUCI calculation in the UST would be ignored by the eUICC but they would be understood by the 5G ME. The 5G ME may send a GET IDENTITY command or try to read the content of DF 5GS. The GET IDENTITY command would then fail because the eUICC OS does not support SUCI calculation by USIM or the terminal would not find the information required for the SUCI calculation.

In addition, in TCA SAIP v2.3.1, the ServiceList was expanded to include the support for 5G, services below were not part of TCA profile package interoperability specifications prior to v2.3.1. but it is part of the UICCCapabilites reported by the eUICC in EUICCInfo2 (Tag ‘BF22’) as per GSMA SGP.22 v2.4:
/* Support of 5G */
get-identity NULL OPTIONAL,
profile-a-x25519 NULL OPTIONAL,
profile-b-p256 NULL OPTIONAL.

Additionally, GSMA SGP.22 v2.4 specifications (Annex F), define profile eligibility checks to be performed prior to any profile download by an operator or the SM-DP+. Therefore, it is possible that even an eSIM profile is feasible to be downloaded into a particular eUICC/iUICC/eSIM/UICC, it is rejected by the SM-DP+ or by the operator because it is determined that they are incompatible (the actual profile download is cancelled before even eUICC/iUICC/eSIM/UICC may reject it). Two types of eligibility checks are currently defined in GSMA specifications:
Static Eligibility Check (SEC): This check based on the static capabilities of the Device and/or the eUICC. A possible implementation is via database knowledge of EID and the TAC of the device. The checks performed are proprietary and responsibility of the MNOs.
Dynamic Eligibility Check (DEC): This check procedure based on the eUICC Info and/or the device capabilities during Profile Download and Installation process. This check is performed by the SM-DP+ on behalf of the MNO.

With regards to 5G, there is a recommendation to be used by SM-DP+ for the eligibility check. As per description below service n°125 must not be present when GET IDENTITY command (defined in 3GPP TS 31.102 and ETSI TS 102 221) is not supported by the eUICC, while the “following recommendations apply to the SM-DP+ for the eligibility check of 5G supporting Device. See also section 4.2, section 5.7.8, and annex H.

The SM-DP+ SHOULD check if the eUICC supports GET IDENTITY, i.e., getIdentity bit is set in uiccCapability. If it is not supported, the SM-DP+ SHOULD NOT configure service n°125 in EF_UST and SHOULD NOT provide DF_SAIP in the Profile Package.

The SM-DP+ SHOULD check if the eUICC supports SAIP v2.3.1 (or higher). If it is not supported and the Profile is intended to contain DF_5GS, the SM-DP+ SHOULD provide the DF_5GS by using Generic File Management PE.

The SM-DP+ MAY provide a Profile with additional 5G features even if the Device does not support 5G core access (neither eutran5gcSupportedRelease nor nr5gcSupportedRelease is present in deviceCapability).

As to 3GPP TS 31.102 R16, Service n°124 and Service n°125 provides indication if SUCI calculation is available (Service n°124) and if it is going to be calculated by the device or by the eUICC (Service n°125): Service n°125 shall only be taken into account if Service n°124 is declared “available”. If Service n°124 and Service n°125 are declared “available”, the “SUCI calculation is to be performed by the USIM”. If Service n°124 is declared “available” and Service n°125 is not declared “available”, the “SUCI calculation is to be performed by the ME”. Based on the extracts from the specifications described above, the standards define certain barriers to prevent that a 5G eSIM profile can be installed in non-5G eUICC/iUICC/eSIM/UICC. This has the consequence that is not possible to define a single profile to address eUICC/iUICC/eSIM/UICC supporting 5G and at the same time legacy eUICC/iUICC/eSIM/UICC supporting 4G only.

In view of the above, methods, specifications, and standards known as prior art for configuring secure elements for user devices, may thus not fully satisfy all requirements regarding their deployability and availability on the one hand, as well as interoperability and functional safety on the other hand. In particular, incompatibilities may arise, if user devices and secure elements have different development standards and dates. Even if it is desirable that both, the user device and the secure elements have the same origin and preferably same state of development in order to ensure functional safety and security, due to deployability and availability restrictions, this may not be always assured. On the contrary, the user devices and the secure elements may have different origins, versions, and/or capabilities, especially if an implementation of a new specification or standard for operating the user devices is expected to be issued during lifetime of the user device and/or respective secure element.

Consequently, production and provision of user devices as well as secure elements may be complicated when different parties are involved in the production process, for example, if one party produces the user device, another party provides the SE/TRE as well as respective personalized software images, and yet another party may be in charge of the diversified data. Furthermore, when the provisioning of certain pieces of data, such as diversified data, is restricted to certain phases of the production process, it places heavy restrictions on timelines and planning. This potentially complicates certain aspects of production, such as stock accumulation, especially if data requirements cannot be well defined in advance. Such restrictions in timelines and definitions may further limit the functionality, especially a spectrum of (future) capabilities, of the user device and/or secure elements, may compromise their functional safety and security, or may even lead to that they cannot be configured properly, keeping in mind that not only the user devices, secure elements, and respective OS but also related data structures including diversified data can be affected by timeline-related restrictions and possible updating procedures, such as the introduction of new device capabilities.

### SUMMARY

It may be seen as an object to provide user devices and/or secure elements which can be configured in a flexible manner according to current and/or future requirements. In particular, it can be regarded as an objective to provide a way of handling secure elements and their data structures in such a way that a future-proof range of functions, security and protection can be guaranteed without impairing the usability, availability and/or data integrity, in particular communication capability, of the user devices or their secure elements. These objects are at least partly achieved by the subject-matter of the independent claims.

According to an aspect, a method of configuring a secure element for a user device, in particular for communication via mobile telecommunication networks, the method comprising the steps of preparing a user profile dataset for a user to operate a secure element, such as an eUICC, of the user device, based on diversified data for personalizing the secure element, providing the user profile dataset to the secure element selecting at least a part of a dynamic data subset of the user profile dataset based on a connection capability of the user device.

According to an aspect, a configuration program for configuring a secure element for a user device, in particular for communication via mobile telecommunication networks, wherein the configuration program comprises instructions which, when the configuration program is executed by a server device, a user device, and/or a secure element, cause the server device, the user device, and/or the secure element, respectively, to carry out a corresponding method.

According to an aspect, an application program dataset for operating a secure element, such as an eUICC, of a user device, in particular for communication via mobile telecommunication networks, is provided, wherein the application program dataset is configured to carry out a corresponding method and/or configured with a corresponding configuration program.

According to an aspect, a user profile dataset for a secure element, such as an eUICC, of a user device, in particular for communication via mobile telecommunication networks, is provided, the user profile dataset comprising a dynamic data subset configured by a corresponding method, with a corresponding configuration program and/or with a corresponding application program dataset.

According to an aspect, a computer-readable data carrier having stored thereon a corresponding configuration program, application program dataset and/or user profile dataset is provided.

According to an aspect, a secure element for a user device, in particular for communication via mobile telecommunication networks, is provided the secure element configured to carry out a corresponding method, configured with a corresponding configuration program, having stored thereon a corresponding configuration program, a corresponding application program dataset, and/or a corresponding user profile dataset.

According to an aspect, a user device, in particular a mobile device or an IoT device to be configured for communication via mobile telecommunication networks by a user, is provided, wherein the user device is configured to carry out a corresponding method, comprises a corresponding configuration program, a corresponding computer-readable data carrier, and/or a corresponding secure element.

According to an aspect, a server device, in particular a security server providing a secure location for handling subscriber profiles for enabling access mobile telecommunication networks, is provided, wherein the server device is configured to carry out a corresponding method, comprises a corresponding configuration program according to claim, a corresponding application program dataset, a corresponding user profile dataset, and/or a corresponding computer-readable data carrier.

The application program dataset may at least in part be provided on the secure element and can be configured to interact with the user device and/or at least one network terminal thereof. In other words, the application program dataset may at least partly run on the secure element, for example, as a part of an operating system dataset configured to operate the secure element. Additionally, an installation program dataset can be provided for installing and/or managing the application program dataset, such as for installing and/or updating an operating system dataset or respective update data subsets, including the application program dataset. Both, the installation program dataset and the installation program dataset may be integrated as data subsets into a customization dataset, such as a firmware suite allowing for customization of data on the secure element as described herein.

The application program dataset may be provided as a part of an operating system dataset of the secure element and/or may be configured to interact with the operating system dataset. A complete operating system dataset and/or subsets thereof may comprise the application program dataset. The operating system dataset and/or application program dataset may be configured to read, write, delete, manage and/or administer any kind of data stored on the secure element and such are the user device. Data objects can be and/or comprise any kind of data element or constructs of data, including, but not limited to data gateways, data accesses, data streams, data blocks, data files, or alike, such as binaries, sounds, images, videos, text, emails, documents, images, folders, etc. The expression “dataset” can be understood as any kind of data composition, such as a file, including source code, object code, or binaries, which may have or fulfil a certain technical function.

The user profile dataset can comprise the dynamic data subset and a static data subset. The Dynamic data subset can comprise settings, such as values, parameters, definitions and/or respective tables or alike. The user profile dataset may be stored in a secure memory region of the secure element. The dynamic data subset may be configured for at least partly controlling an operation of the secure element and/or to handle the diversified data. Such diversified data can be defined and/or provided by a Connectivity Service Provider (CSP).

The static data subset can determine a basic structure of the user profile dataset. The dynamic profile subsets can be associated with standardized or different structures of static profile subsets having the same or at least similar basic user profile dataset configuration in common. Thereby, in the sense of an Adaptive Profile Management (AMP), the user profile dataset can be adapted to requirements and/or demands according to a respective subscription and/or user device which is not known at the time of manufacturing or even issuing the user device and/or the secure element. Hence, a selection of basic structure of the user profile dataset can first be carried out according to the type of SE and the dynamic data subset can be defined later in the field based on and adapted to respective device capabilities, as they may evolve.

The proposed solution allows to provide a user profile datasets that can work with different variants of products, i.e. different kinds of user devices and secure elements. Thereby, compatibility and interoperability of different devices and secure elements may be improved. An overall variation and number of settings that trusted entities and/or CSPs are providing for different products or ranges of products can handled without compromising functional safety and reliability.

The solution has the advantage over the prior art, that respective user profile datasets can be delivered to any manufacturing facility, including OEM/ODM vendor facilities, as well as fabrication facilities of the secure element, regardless of a change to standards and/or specifications relating to the user device between the delivery and a later point of the time of deployment of user devices and/or the secure elements to customers. At first, the diversification data allows for generating the dynamic data and/or static data subsets of the user profile datasets. Then, the user datasets can be deployed to customers for the configuration of the user devices and/or the secure elements, allowing them to adopt upcoming or following standards and/or specifications along with a respective functional spectrum, safety, and security as required for operating the user devices and/or the secure elements.

Further developments can be derived from the dependent claims and from the following description. Features described with reference to a user device, secure element, server device and components thereof may be implemented as method steps, or vice versa. Therefore, the description provided in the context of the user device, secure element, server device and their components apply in an analogous manner also to respective methods. In particular, features and functions of the user device, secure element, server device and their components may be implemented as method steps which in turn may be implemented as respective device features or functions.

According to a possible embodiment of the method, the diversified data and/or the dynamic data subset include or includes, respectively, security credentials. The security credentials can be provided as a set of security credentials based on the respective definition of the dynamic data subset. The dynamic data subset can be at least partly created based on security credentials. For example, certain components or structures of the dynamic data subset may be selected according to a type of or respective specifications for security credentials to be used by the respective user profile dataset. This helps in assuring a future-proof functional spectrum, safety, and security, while not compromising deployability and availability of user devices and their secure elements.

According to a possible embodiment of the method, the diversified data and/or the dynamic data subset comprise or comprises, respectively, at least one profile identifier, at least one subscription identifier, and/or at least one security key. The at least one profile identifier can be provided in the form of a unique serial number of the user profile dataset, for example, in the form of a unique subscriber number identifying a user, such as an IMSI. The at least one subscription identifier can be provided in the form of an identifier of the secure element, such as an ICCID. The at least one security key can be provided in the form of a unique individual key per profile dataset. Consequently, the dynamic data subset may be created based on the at least one profile identifier, at least one subscription identifier, and/or at least one security key. This further helps in assuring a future-proof functional spectrum, safety, and security, while not compromising deployability and availability of user devices and their secure elements.

According to a possible embodiment of the method, the dynamic data subset is configured to conceal and/or encrypt the diversified data. For example, the IMSI may be concealed and/or encrypted as a SUCI in 5G. Thereby, the dynamic data subset can help in protecting the diversified data, such as the IMSI, against unauthorised access, for example, when this is required according to respective connection capabilities of the user device. This additionally helps in assuring a future-proof functional spectrum, safety, and security, while not compromising deployability and availability of user devices and their secure elements.

According to a possible embodiment of the method, the connection capability relates to at least one communication standard. The dynamic data subset can be selected and/or adapted according to a first communication standard and/or a second communication standard. The static data subset can be configured such that it is device and/or standard-independent, while the dynamic data subset can be configured such that it can be selected and/or be adapted according to respective requirements of a communication standard (e.g., 4G, 5G, LTE, etc.). This allows for dynamic configuration of user profile datasets according to respective communication standards, and thus further helps in in assuring a future-proof functional spectrum, safety, and security, while not compromising deployability and availability of user devices and their secure elements.

According to a possible embodiment, the method further comprises the step of assigning first profile capabilities and/or second profile capabilities to the dynamic data subset based on the communication capability of the user device. The first profile capabilities and/or second profile capabilities can be selected and/or adapted according to respective device capabilities, such as whether the user device is configured according to a first application standard and/or a second communication standard, respectively. Respective profile capabilities can thus be dynamically implemented as desired or required to match the device capabilities. This further allows for dynamic configuration of user profile datasets according to respective communication standards, and thus further helps in in assuring a future-proof functional spectrum, safety, and security, while not compromising deployability and availability of user devices and their secure elements.

According to a possible embodiment, the method further comprises the step of querying the user device with the secure element regarding the connection capabilities. Querying the user device with the secure element may involve sending a request command from the secure element to the user device. The user device may answer to the query and/or request command by sending back a response message or confirmation message to the secure element. This facilitates an information and data exchange between the user device and the secure element regarding device capabilities.

According to a possible embodiment, the method further comprises the step of providing the connection capabilities of the user device to the secure element upon every startup of the user device and/or initialisation of the secure element. For example, the secure element may query the user device upon every start-up of the user device and/or initialisation of the secure element. Alternatively, or additionally, the user device may automatically send a response message or confirmation message or alike to the secure element upon every start-up and/or initialisation. This further helps in enhancing the data exchange between the user device at the secure element regarding device capabilities, in particular in that the secure element can be kept updated about the device capabilities.

### BRIEF DESCRIPTION OF THE DRAWINGS

FIG. 1 is a schematic illustration of a configuration system for carrying out a method according to the present disclosure.

FIG. 2 is a schematic illustration of the preparation of a user profile dataset from dynamic data subsets and a static data subset according to the present disclosure.

FIG. 3 is a schematic illustration of a process according to the present disclosure for selecting a dynamic data subset based on a respective device capability.

### DETAILED DESCRIPTION OF EMBODIMENTS

The following detailed description is merely exemplary in nature and is not intended to limit the disclosure and uses of the disclosure. Furthermore, there is no intention to be bound by any theory presented in the preceding background or the following detailed description. The representations and illustrations in the drawings are schematic and not to scale. Like numerals denote like elements. A greater understanding of the described subject matter may be obtained through a review of the illustrations together with a review of the detailed description that follows.

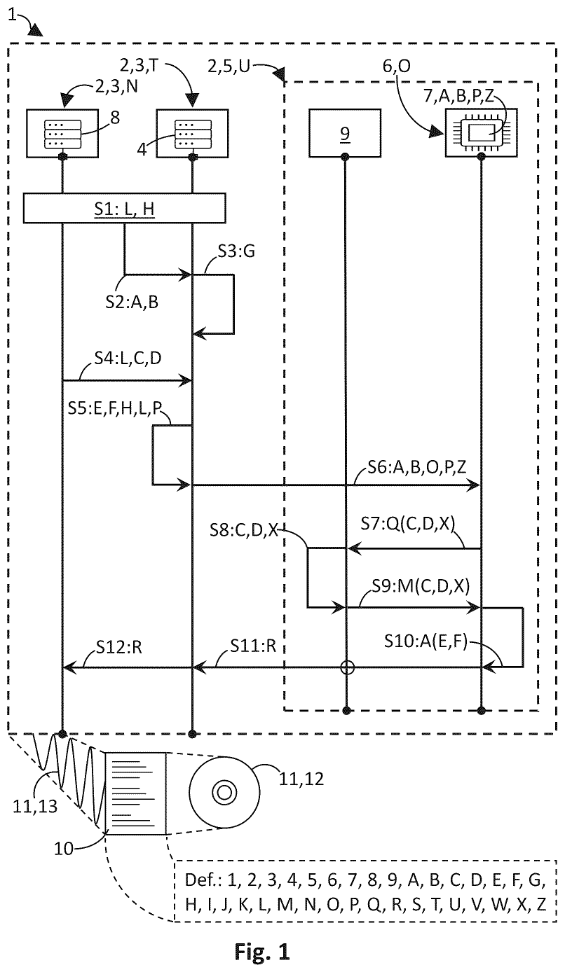

FIG. 1 shows a schematic illustration of a configuration system 1 comprising a computing device 2, for instance, in the form of a server device 3 controlled by a trusted entity T, having a hardware security module 4 adapted to store, manage and/or provide user profile datasets P for configuring a further computing devices 2, for example, in the form of a user device 5 which may be embodied as an Internet of Things (IoT) device, such as a multimedia device, camera, speaker, household appliance, measurement device, industrial installation, vehicle, vending machine, or alike, to be associated with a machine entity, and/or as a personal mobile device, such as a smartphone, smartwatch, etc., to be associated with a personal entity. For example, the server device 3 of the trusted entity T may be provided in the form of a Server for Subscription Manager Data Preparation+ (SM-DP+).

In the present example, the user device 5 may be adapted for communication via a telecommunication N by means of at least one user profile dataset P to be saved in a respective secure element 6 or tamper resistant element (TRE), such as an UICC, eUICC, iUICC, SIM, eSIM, iSIM, SE, eSE, or alike, provided in the form of a computer chip. The user profile data sets P can be generated based on respective personal records contained as diversified data L in perspective data files on the computer device 2, in particular, the hardware security module 4 thereof, controlled by the trusted entity T. For storing and managing user profile data sets P on the secure elements 6, an operating system dataset O is installed on the secure element 6, for example, in a secure storage location 7 provided on the secure element 6. A further computing device 2, for instance, the form of a further server device 3, can be controlled by a network and/or connectivity provider managing the mobile telecommunication network N which may provide the diversified data L to the trusted entity T for creating the user proper datasets P.

The user profile datasets P comprise a dynamic data subset A and a static data subset B. The dynamic data subsets A can enable application of certain functions of the secure element 6 according to respective device capabilities X of the user device 5. The dynamic data subset A may have and/or provide at least a first profile structure E and a second profile structure F which can comprise respective data objects, values, parameters and/or tables for adopting certain functions of the secure element 6 to respective device capabilities X.

For example, the device capabilities X may involve a first communication standard C and/or second communication standard D. The first profile structure E and the second profile structure F may relate to the first communication standard C and/or the second communication standard D, respectively. Furthermore, the dynamic data subset A and static data subset B may be associated to certain diversification ranges of the diversified data L. A management application 8 may be provided for managing the diversified data L on the side of the network provider providing the moment communication network N and/or trusted entity T. An application program dataset Z may be provided for managing the user profile dataset P and its components as well as functions on the side of the secure element 6, for example in the form of an applet, such as a Java card applet.

The network provider N, entity T and/or user U may communicate with the user device 5, in particular the secure element 6, for example, through a communication interface 9 of the user device 5. The communication interface 9 may be provided in the form of a logical end-to-end interface enabling secure communications between the hyper security module 4, and/or the remote management application 8 and the secure element 6, which can be used to transfer data packages, such as eUICC Packages. For example, the communication interface 9 may be provided as a part of a local management application, such as a Local profile assistant (LPA), or an IoT Profile Assistant (IPA), which may take the form of a Local/IoT Profile Assistant (L/IPAd) provided to the user device 5, and/or a Local/IoT Profile Assistant provided (L/IPAe) arranged in the secure element 6.

Furthermore, the operating system dataset O and/or the user profile P comprises security credentials H, which may include a profile identifier I, authentication certificates J and/or security keys K. The security credentials H may comprise any kind of credentials defined by e.g., the GSMA, or alike. The security keys K may comprise any kind of cryptographic code or key element which may be adapted to interact with the user devices 5, the secure elements 6, and/or the server device 3 of the trusted entity T as an issuer of any part of the operating system dataset O and/or any component thereof. The authentication certificates J may be any kind of electronic certificate, for example, that can be issued by the trusted entity T, for authenticating an origin of the user devices 5, the secure elements 6, the secure storage location 7, and/or the operating system dataset O. Transmission lines (not shown) may be provided for handling and/or transferring the operating system dataset O and/or user profile dataset P may comprise any kind of wired and/or wireless transmission chains, including the Internet (for transmissions “Over-The-Air”) as well as other physical and/or non-physical data carriers, which can be configured and secured as desired and required. Furthermore, a request signal Q or activation command may be provided which may be allowed to be executed in order to obtain an activation signal R or for confirmation message when activating the operating system dataset O and/or user profile dataset P.

In any of the embodiments of the configuration system 1 as described herein, in particular the computing devices 2, can be configured to execute a computer program in the form of a configuration program 10. A computer-readable data carrier 11 can have stored thereon the configuration program 10 and may take the form of a computer-readable medium 12 and/or data carrier signal 13. When carrying out the configuration program 10, the configuration system 1 and any components thereof communicate as specified in the configuration program 10. Parameters associated with and/or underlying the security system 1, any of the components thereof and/or any steps S carried out thereby, can be defined in and/or by the configuration program 10 and/or the application program dataset Z.

In a first step S1, the network provider N and/or secure entity T, for example by using the respective server device 3, hardware security module for and/or management application 8 and/or may provide can be provided with, respectively, the diversified data L and/or security credentials. In a second step S2, the dynamic data subset A and/or static data subset B may be selected and/or created. In a third step S3, a set G or group of dynamic data subsets A and/or of static data subsets B may be prepared and/or created.

In a fourth step S4 an order may be placed, for example, based on specifying diversified data L which may be intended to create at least one specific user profile dataset P for a specific user U or group of users U. The order can be placed by the network provider of the mobile telecommunication network N and can be sent to the trusted entity T and may comprise an indication of possible communication standard C, D for which the user profile dataset P of the group of profiles is intended to be used. Based on the order, in the fifth step S5, the user profile datasets P may be created, for example, based on the first profile structure E and/or second profile structure F which can be determined based on the respective communication standard C, D. In the course of creating the user profiles P, they may be provided with respective security credentials H and/or diversified data. In a sixth step S6, the secure element 6 may be issued and/or provided with the operating system dataset O, user profile dataset P including at least one dynamic data subset A and the static data subset B, and/or the application program dataset Z.

In a seventh step S7, for instance after the user U or group of users U that are intended to apply the user profile data sets P based on the respective order, possibly after activating, enabling, installing and/or inserting the secure element 6 in the user device 5, can let the secure element 6 send a request command Q or query to the user device 5 regarding device capabilities X, for example, in that the application program dataset Z and/or the operating system O of the secure element 6 contacts the user device 5 and/or the communication interface 9, such as a terminal or modem, thereof. Alternatively, or additionally, the secure element 6 may query the user device 5 upon every start-up and/or initialization of the user device 5 and/or the secure element 6 regarding the device capabilities X, as they may change due to certain enhancements, installations, selections, updates, or alike. In an eighth step S8, the user device 6 can assess its device capabilities X, for example, in assessing and/or compiling a list of respective communication standards, such as the first communication standard C and/or the second communication standard D, that the user device 5 is capable of. In a ninth step S9, the user device 5 may send a response message M back to the secure element 6, in particular to the application program dataset C and/or the operating system O, thereof, informing the secure element 6 of the device capabilities X of the user device 5.

In a tenth step S10, the dynamic data subset A may be selected and/or adapted according to the device capabilities X, for example, in that first profile capabilities E and/or second profile capabilities F are being enabled. Furthermore, the user U may activate the user profile dataset P, for example, by means of respective security credentials H, such as the profile identifier I, authentication certificate J, and/or security key K. In an eleventh step S11 asset or twelfth step S12, an activation signal R, such as a registration signal or activation confirmation message, may be sent from the user device 5 to the trusted entity T the mobile telecommunication N, respectively. The activation signal R can be triggered by the user U through activation or can be automatically sent, for example, by the secure element 6 through the communication interface 9 to the server device 3 of the trusted entity T and/or the mobile telecommunication network N. Such a activation signal R can involve respective security credentials H, such as the profile identifier I, authentication certificate J, and/or security key K with which the respective user device 5 and/or the secret element 6 thereof, may authenticate itself.

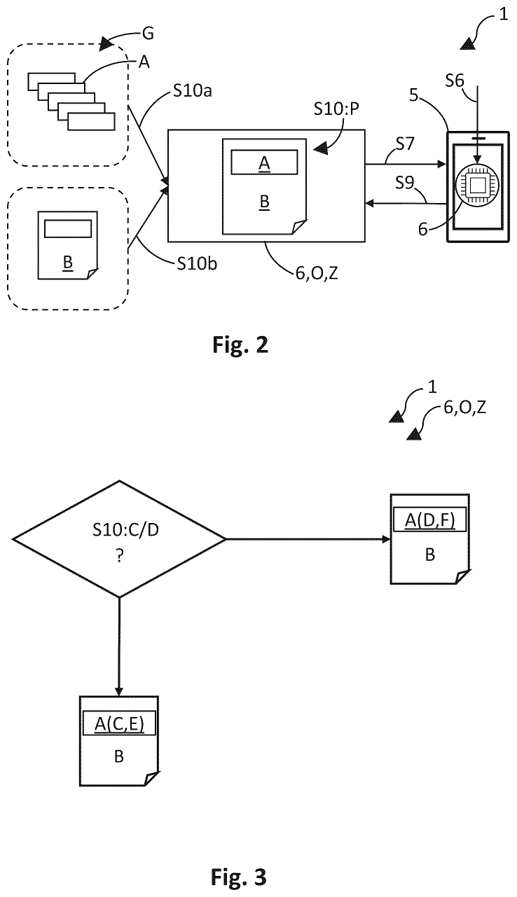

FIG. 2 shows a schematic illustration of the preparation of a user profile dataset P from dynamic data subsets A and a static data subset B according to the present disclosure. After issuing the user profile dataset P and/or the secure element 6, for example, upon start-up and/or initialization of the user device 5, the secure element 6, and/or a combination thereof, the operating system data set O and/or the application program dataset Z can initialize an adaptation, assembly, configuration and/or selection of the user profile dataset P. Therefore, in the seventh step S7, the operating system data set O and/or the application program dataset Z can query or request the user device 5 to provide the device capabilities X, for example, by means of the request command. Upon receipt of the device capabilities X information from the user device 5 in the ninth step S9, e.g. by the response message M, the secure element 6, in particular, the operating system dataset O and/or application program dataset Z can configure, for example merge, the corresponding dynamic data subset A with the static data subset B and thus provide the user profile dataset P in line with the device capabilities X in the tenth step S10 which may involve a tenth sub-step S10a for adapting, configuring and/or selecting the dynamic data subset A, for example, from a set of group G of dynamic data subsets A, and/or a further tenth sub-step 10b for adapting, configuring and/or handling the respective static data subset B.

FIG. 3 shows a schematic illustration of a process according to the present disclosure for selecting a dynamic data subset A based on a respective communication standard C, D. For example, in the tenth step S10, it may be decided according to the respective device capabilities X, whether a dynamic data subset A for a user profile dataset P configured to be used according to a first communication standard C and/or second communication standard D, such as 4G and 5G, respectively, are supposed to be provided. Such an evaluation can be based on whether there is a support for a certain profile version offering a respective first profile capability E and/or a second profile capability F for the first communication standard C and/or the second communication standard D, respectively. However, it should be understood that the device capabilities X may not merely comprise communication standards, but also capabilities, such as bandwidths, frequencies, memory space, processor performance, battery life, geolocation, communication and operation capabilities, including but not limited to any user interface capabilities, and/or capabilities of the communication interface 9, or alike.

Any dynamic profile subset A as described herein can comprise personalized identifiers (ICCID, IMSI, etc.), personalized keys (network keys, SIM OTA keys) and/or any personalized (=distinctive value per eSIM profile, “per ICCID”, e.g., PIN codes) content of the eSIM profile. Corresponding Dynamic Profile Data can always be bound to a certain profile type, to allow ICCID addressing. Which files that are included in the dynamic profile subset A can be defined by as desired or required by a respective application. Any static profile subsets B may provide a static part of the eSIM profile definition, containing files and applets. In an AirOn360 APM context, each static profile structure may be identified by a Profile Structure ID and/or customerMaterial-Id, as there might be different static profile structures. In “classic” AirOn inventory, the customerMaterial-Id may be associated with a Profile Type. A corresponding adaptive profile type may consist of one or more static profile structures and set of dynamic profile data.

The present example embodiments may be used to provide a mechanism for the user device 5 to inform the secure element 6, such as an eUICC/iUICC/eSIM/UICC, if the user device 5 supports of 5G capabilities. For example, a TERMINAL PROFILE as defined in ETSI 102.221 and ETSI 102.223 can be used and include a bit configuration where the user device can set the value in case of it has 5G capabilities, otherwise the bit can remain not configured (unchecked, set as RFU, bit=0 as indicated in ETSI 102.223). With this information, the secure element 6 may implement measures to maximize or improve the capabilities of the user device 5. For instance, the operating system dataset O and/or application program dataset Z being aware of that the device supports 5G capabilities can adapt the user profile dataset P accordingly (i.e., setting the right value in EF_UST table, make SUCI_INFO visible to the device, activate certain features, etc.). This may allow the definition of a single SKU profile, for example, by means of a respective static data subset B, compatible with a 4G capable secure element 6 configuration only, that can be converted in 5G profile in case of the device shows support for 5G, for example, by adapting, configuring and/or selecting the dynamic data subset A accordingly.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It will be understood that various changes may be made in the function and arrangement of elements described in an exemplary embodiment without departing from the scope of the claims.

Additionally, it is noted that “comprising” or “including” does not exclude any other elements or steps and “a” or “an” does not exclude a multitude or plurality. It is further noted that features or steps which are described with reference to one of the above exemplary embodiments may also be used in combination with other features or steps of other exemplary embodiments described above. Reference signs in the claims are not to be construed as a limitation.

1. A method of configuring a secure element for a user device for communication via mobile telecommunication networks, the method comprising the steps of
preparing a user profile dataset for a user to operate a secure element of the user device based on diversified data for personalizing the secure element,
providing the user profile dataset to the secure element, and
selecting at least a part of a dynamic data subset of the user profile dataset based on a connection capability of the user device.

2. The method according to claim 1, wherein at least one of the diversified data and the dynamic data subset include security credentials.

3. The method according to claim 2, wherein the at least one of the diversified data and the dynamic data subset comprises at least one of at least one profile identifier, at least one subscription identifier, and at least one security key.

4. The method according to claim 1, wherein the dynamic data subset is configured to at least one of conceal and encrypt the diversified data.

5. The method according to claim 1, wherein the connection capability relates to at least one communication standard.

6. The method according to claim 1, further comprising the step of assigning at least one of first profile capabilities and second profile capabilities to the dynamic data subset based on the communication capability of the user device.

7. The method according to claim 1, further comprising the step of querying the user device with the secure element regarding the connection capabilities.

8. The method according to claim 1, further comprising the step of at least one of providing the connection capabilities of the user device to the secure element upon every startup of the user device and initialisation of the secure element.

9. The method according to claim 1, wherein the security element is an eUICC.

10. A configuration program for configuring a secure element for a user device for communication via mobile telecommunication networks, wherein the configuration program comprises instructions which, when the configuration program is executed by a processor, cause the processor to carry out a method comprising the steps of
preparing a user profile dataset for a user to operate a secure element of the user device, based on diversified data for personalizing the secure element,
providing the user profile dataset to the secure element, and
selecting at least a part of a dynamic data subset of the user profile dataset based on a connection capability of the user device.

11. The configuration program of claim 10, wherein the processor is associated with a server device.

12. The configuration program of claim 10, wherein the processor is associated with the user device.

13. The configuration program of claim 10, wherein the processor is associated with a secure element.

14. The configuration program of claim 10, wherein the secure element comprises an eUICC.

15. A non-transitory computer readable medium comprising
a dataset for operating a secure element of a user device for communication via mobile telecommunication networks, wherein the dataset is configured to carry out a method comprising
preparing a user profile dataset for a user to operate a secure element of the user device based on diversified data for personalizing the secure element,
providing the user profile dataset to the secure element, and
selecting at least a part of a dynamic data subset of the user profile dataset based on a connection capability of the user device.

16. The non-transitory computer readable medium of claim 15, wherein the secure element comprises an eUICC.

17. The non-transitory computer readable medium of claim 15, wherein the dataset is a user profile dataset for the secure element of the user device.

18. The non-transitory computer readable medium of claim 15, comprising a computer-readable data carrier having stored thereon the user profile dataset.

19. The non-transitory computer readable medium of claim 15, wherein the user device comprises at least one of a mobile device and an IoT device.

20. The non-transitory computer readable medium of claim 15, comprising a security server providing a secure location for handling user profiles based on the dataset.
